(19) United States
(12) Patent Application Publication
(10) Pub. No.: US 2019/0124963 A1
(43) Pub. Date: May 2, 2019

(54) Dehydrated Edible Meat Chip Snack for Humans and Pets

(71) Applicants: Darlene Fantel, Lindenhurst, NY (US); Robert S. Fantel, Lindenhurst, NY (US)

(72) Inventors: Darlene Fantel, Lindenhurst, NY (US); Robert S. Fantel, Lindenhurst, NY (US)

(21) Appl. No.: 16/194,326

(22) Filed: Nov. 19, 2018

(51) Int. Cl. A23L 13/60; A23K 10/20

(52) U.S. Cl. CPC A23L 13/67; A23V 2002/00; A23K 10/20

(57) ABSTRACT

Provided are human and pet edible meat chip snacks exhibiting solid physical characteristics with or without the infusion of additional ingredient(s). The incorporation of additional ingredient(s) through our infusion process into the snack on a cellular level boasts potential health, nutritional, increased palatability, increased preservation and or visual appearance benefits. These snacks are highly palatable to humans and pets alike, resulting in a well suited, highly efficient delivery of targeted ingredient(s) and their intended potencies and pre-determined purpose.

### BACKGROUND

Humans and pets have been consuming dehydrated snacks for many years. Although there is a current multitude of dehydrated snacks available for individual human and pet consumption on the market today, most products fall into two processed categories:
A) Meats, fruits or vegetables being processed into a mash mixture, incorporating additional ingredients which are then molded or formed.

This cumulative process of ingredients enhances the product as a combined whole, potentially for health, nutritional, palatability, visual appearance or preservation and/or multiple combinations thereof.
B) Meats, fruits or vegetables sliced as a singular piece from the source as a whole, are either powder coated or base coated with additional ingredients.

This cumulative process of ingredients enhances the product as a combined whole, potentially for health, nutritional, palatability, visual appearance or preservation and/or multiple combinations thereof.

Below are three major drawbacks of the above listed processes (A) and (B).
1) Excessive Sodium and/or chemical food preservatives applied to product to ensure the longevity of the products lifespan (shelf life).

Today's consumer frowns upon this method and relentlessly searches for a natural, healthy alternative product(s) for their own consumption as well as their pets.
2) Ingredients attached to the product through powder coatings or baste coatings.

Today's consumer realizes the potential for powder or baste coating cohesiveness to fail by either scraping or wearing off while still within its packaging. This failure has the potential to reduce the intended potency of the health, nutritional, palatable, colorant and or preservative value.

Also, another problem due to the exterior coatings of treats/snacks realized by consumers, is the high potential for staining damage to occur to carpets, clothing, furniture, etc. The potential for this damage is much higher in pet treats, however human snacks due pose similar potential concerns.
3) Some pet food/treat companies source their meat products from foreign international sources.

It is a growing concern with consumers the necessity for the well-being of their pet(s), that treats are to be made with USDA approved meats where applicable. The USDA approval on meat products sold in the United States of America ensures the safety for human consumption. Unfortunately, this is not inclusive for the pet food/treat market. In the past several years, pet foods and treats from some companies who obtained meat ingredients sourced from foreign countries (Non-USDA Approved), have negatively affected some pets on a health basis. In some cases, pets have experienced symptoms ranging from excessive vomiting, seizures and in severe cases, the death of the pet.

Clearly it is obvious, there is a need in both the human and pet markets for improved products in which potential health, nutritional, increased palatability and or visual appearance benefits can be achieved through a healthier, safer consumer friendly snack.

Our edible meat chip snack is processed following FDA guidelines and standards, utilizing USDA approved meats for both human and pet consumption where applicable.

Please note that we take pride in calling our product a snack not a treat. As health-conscious individuals, we believe in proper nutrition and promoting good health for people and pets. A healthy alternate to snacking leads to improved health benefits.

### SUMMARY OF THE DISCLOSURE

Embodiments of the present disclosure provide a food product (an edible meat chip snack product for human and pet consumption) and subsequent method thereof making the same. Described briefly in architecture, one embodiment of the food product among others can be achieved as follows: The food product originates as a singular meat source. The meat source for example may include chicken, turkey, beef, pork, duck, lamb, fish, elk, and/or alligator to name a few but not limited to the examples mentioned, which is sliced/cut into naturally occurring (Natural) varying dimensions. Wherein the meat food product has undergone dehydration which removes a percentage of the water the chip has retained on a cellular level. The timeframe of this process ranges from 1.5-4 hours dependent upon the varying thickness of the sliced/cut meat chip, and the intended moisture content of the meat chip thereof, at a temperature of 165° F. Subsequently with the successful completion of the dehydration process, our infusion process will commence. The introduction (Infusion) of additional ingredient(s) through our water-based ingredient(s) infusion mixture process allows for the partial rehydration of the meat chip on a cellular level.

Our infusion process incorporates the additional mixture of ingredient(s) which may include dietary supplement ingredient(s) and/or food additives for the potential of providing health benefits, increased palatability benefits, increased product shelf life, targeted product appearance and product preservation, to name a few but not limited to the examples mentioned. Subsequently, the utilization of the first dehydration process in conjunction with the infusion process, creates a unique absorption method for the meat chip on a cellular level. The meat cells which have been dehydrated, exhibit a natural propensity to accept additional ingredient(s) efficiently and effectively through a water-based mixture in an attempt to rehydrate their dehydrated cells. As such, both water and ingredient(s) are absorbed by the dehydrated meat cells in a more thoroughly uniform distribution throughout the meat chip. This additionally aids in a more distinctive palatability of the meat chip also ensuring the effective and efficient potency of all intended additional ingredient(s) while alleviating some of the potential downfalls of current market products which can potentially damage personal belongings due to their coating(s) failure. Additionally, the meat chip then will undergo the baking process to not only remove the additional water as a result of the infusion process but to continue further in the successful dehydration process of the meat chip moisture content to the intended 4%-12% final total moisture content of said meat chip. Furthermore, the baking process locks in the added infused ingredient(s) and natural flavor while adding a distinctive palatable taste and desirable texture.

Another embodiment of the present disclosure can also be viewed as providing a subsequent method thereof making the same food product (an edible meat chip snack product for human and pet consumption) with pre-determined “Trimmed” characteristics of the original meat source. Described briefly in architecture, one embodiment of the food product can be achieved as follows: The food product originates as a singular meat source whose physical Natural characteristics have been altered (Trimmed) to a pre-determined shape and size, then subsequently sliced/cut into varying dimensions. The meat source for example may include chicken, turkey, beef, pork, duck, lamb, fish, elk, and/or alligator to name a few but not limited to the examples mentioned. Wherein the meat chip snack has undergone dehydration which removes a percentage of the water the chip has retained on a cellular level. The timeframe of this process ranges from 1.5-4 hours dependent upon the varying thickness of the sliced/cut meat chip, and the intended moisture content of the meat chip thereof, at a temperature of 165° F. Subsequently with the successful completion of the dehydration process, our infusion process will commence. The introduction (Infusion) of additional ingredient(s) through our water-based ingredient(s) infusion mixture process allows for the partial rehydration of the meat chip on a cellular level.

Our infusion process incorporates the additional mixture of ingredient(s) which may include dietary supplement ingredient(s) and or food additives for the potential of providing health benefits, increased palatability benefits, increased product shelf life, targeted product appearance and product preservation, to name a few but not limited to the examples mentioned. Subsequently, the utilization of the first dehydration process in conjunction with the infusion process, creates a unique absorption method for the meat chip on a cellular level. The meat cells which have been dehydrated, exhibit a natural propensity to accept additional ingredient(s) efficiently and effectively through a water-based mixture in an attempt to rehydrate their dehydrated cells. As such, both water and ingredient(s) are absorbed by the dehydrated meat cells in a more thoroughly uniform distribution throughout the meat chip. This additionally aids in a more distinctive palatability of the meat chip also ensuring the effective and efficient potency of all intended additional ingredient(s) while alleviating some of the potential downfalls of current market products which can potentially damage personal belongings due to their coating(s) failure. Additionally, the meat chip then will undergo the baking process to not only remove the additional water as a result of the infusion process but to continue further in the successful dehydration of the meat chip moisture content to the intended 4%-12% final total moisture content of said meat chip. Furthermore, the baking process locks in the added infused ingredient(s) and natural flavor while adding a distinctive palatable taste and desirable texture.

The present disclosure comprised of other systems, methods, advantages and features thereof will be or become obvious to individual(s) with expertise in the art upon examination of the subsequent drawings and detailed description. It is the intended within the scope of the present disclosure that all such additional systems, methods, advantages and features included within this description, be protected by the accompanying claims.

### BRIEF DESCRIPTION OF THE DRAWINGS

Note: FIGS. 1-18 are identified and located on pages 1-8 of the attached figures and flow charts.

FIG. 1 Flow Chart—The manufacturing process of the “Natural” shaped meat chip snack.

FIG. 2 Flow Chart—The manufacturing process of the “Trimmed” shaped meat chip snack.

FIG. 3 is a top view of a meat source which is numerically represented as 1, in accordance with the first exemplary embodiment of the present disclosure.

FIG. 4 is a top view of a “Natural” meat source of FIG. 3 with cut line markings. Hereinafter, the term “Natural” refers to an unaltered exterior shape of the original meat source. These cut line markings are numerically indicated to associate the directional slice/cut pattern of transverse slice/cuts (against the grain) from longitudinal slice/cuts (with the grain). Furthermore, the transverse slice/cuts of the meat source (FIG. 4) will be numerically represented as 2 and 3 whereas the longitudinal slice/cuts of the meat source (FIG. 4) will be numerically represented as 4 and 5 respectfully, in accordance with the first exemplary embodiment of the present disclosure.

FIG. 5 is a top view of a Natural slice of the meat source of FIG. 4 along the cut lines 2 and 3 hereafter numerically referenced as 1A in accordance with the first exemplary embodiment of the present disclosure.

FIG. 6 is a front view of a Natural slice of the meat source of FIG. 4 along the cut-lines 2 and 3 hereafter numerically referenced as 1A in accordance with the first exemplary embodiment of the present disclosure.

FIG. 7 is a side view of a Natural slice of the meat source of FIG. 4 along the cut-lines 2 and 3 hereafter numerically referenced as 1A in accordance with the first exemplary embodiment of the present disclosure.

FIG. 8 is a top view of a Natural slice of the meat source of FIG. 4 along the cut-lines 4 and 5 hereafter numerically referenced as 1B in accordance with the first exemplary embodiment of the present disclosure.

FIG. 9 is a front view of a Natural slice of the meat source of FIG. 4 along the cut-lines 4 and 5 hereafter numerically referenced as 1B in accordance with the first exemplary embodiment of the present disclosure.

FIG. 10 is a side view of a Natural slice of the meat source of FIG. 4 along the cut-lines 4 and 5 hereafter numerically referenced as 1B in accordance with the first exemplary embodiment of the present disclosure.

FIG. 11 is a top view of a Natural meat source of FIG. 3 with exterior perimeter cut line markings. These cut line markings are numerically indicated to associate the directional slice/cut for the exterior perimeter shaping pattern of the meat source in FIG. 11. Furthermore, the longitudinal slice/cuts of the exterior perimeter shaping pattern of the meat source in FIG. 11 will be numerically referenced as 6 and 7, whereas the transverse slice/cuts of the exterior perimeter shaping pattern of the meat source in FIG. 11 will be numerically referenced as 8 and 9, in accordance with the second exemplary embodiment of the present disclosure. The exterior perimeter cut line markings will establish a pre-determined shape of the meat source subsequently referenced hereafter as “Trimmed”.

FIG. 12 is a top view of a Trimmed meat source of FIG. 11 with cut line markings, hereafter numerically referenced as 2A. Hereinafter the term Trimmed refers to the altered exterior shape of the original meat source. These cut line markings are numerically indicated to associate the directional slice/cut pattern of transverse slice/cuts (against the grain) from longitudinal slice/cuts (with the grain). Furthermore item 10 and item 11 will represent the transverse slice/cuts of the meat source while item 12 and item 13 will represent the longitudinal slice/cuts of the meat source, in accordance with the second exemplary embodiment of the present disclosure.

FIG. 13 is a top view of a Trimmed slice of the meat source of FIG. 12 along the cut-lines 10 and 11 hereafter numerically referenced as 2B in accordance with the second exemplary embodiment of the present disclosure.

FIG. 14 is a front view of a Trimmed slice of the meat source of FIG. 12 along the cut-lines 10 and 11 hereafter numerically referenced as 2B in accordance with the second exemplary embodiment of the present disclosure.

FIG. 15 is a side view of a Trimmed slice of the meat source of FIG. 12 along the cut-lines 10 and 11 hereafter numerically referenced as 2B in accordance with the second exemplary embodiment of the present disclosure.

FIG. 16 is a top view of a Trimmed slice of the meat source of FIG. 12 along the cut-lines 12 and 13 hereafter numerically referenced as 2C in accordance with the second exemplary embodiment of the present disclosure.

FIG. 17 is a front view of a Trimmed slice of the meat source of FIG. 12 along the cut-lines 12 and 13 hereafter numerically referenced as 2C in accordance with the second exemplary embodiment of the present disclosure.

FIG. 18 is a side view of a Trimmed slice of the meat source of FIG. 12 along the cut-lines 12 and 13 hereafter numerically referenced as 2C in accordance with the second exemplary embodiment of the present disclosure.

### DETAILED DESCRIPTION

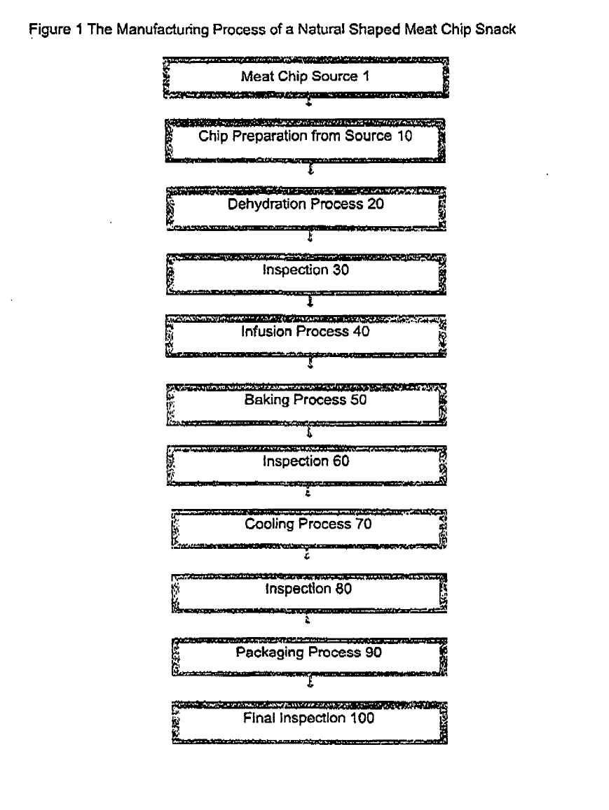

FIG. 1 is a flow chart illustrating a method of making a natural shaped human and pet meat chip snack in accordance with the first exemplary embodiment of the present disclosure.

Hereinafter the term “Natural” refers to an unaltered exterior shape of the original meat source.

It should be duly-noted that any descriptions of the process, whether within the detailed description or within the flow chart blocks represent segments, modules or steps that include one or more detailed instructions for the logical implementation of specific functions as they relate to the process.

The inclusion of alternate implementations or omissions thereof within the scope of work of the present disclosure may incur differences of the execution of said process from that shown and or discussed. This may include concurrent, subsequent and/or in reverse order of process execution dependent upon the involved functionality as understood by those reasonably skilled in the art of the present disclosure.

Referring now to FIG. 1 (the manufacturing process of a natural shaped meat chip snack) a human and pet meat chip snack for carnivorous animals, e.g. humans, canines, felines but not limited to the examples mentioned, is shown with a method of making and packaging of said products.

FIG. 1 whereas item 1 represents the meat chip source utilized for the preparation of the natural shaped meat chip snack. Wherein the meat chip source will undergo a cleaning process to produce an optimum source of meat from which the natural shaped meat chip snack originates.

FIG. 1 whereas item 10 represents the creation of the natural shaped meat chip through the process of slicing and/or cutting a portion/slice from the meat chip source. Wherein the natural shaped meat chip will further have an average thickness in the range of 0.15875 cm to 3.175 cm prior to dehydration process.

FIG. 1 whereas item 20 represents the dehydration process of the natural shaped meat chip. Due to the varying thickness and cellular makeup of the raw natural shaped meat chip, dehydration times may vary. Wherein the natural shaped meat chip will achieve industry average moisture content at completion of dehydration process of under 20%, however the natural shaped meat chip will achieve optimum moisture content at completion of our dehydration process within the moisture range parameter of 4%-12%. Furthermore, a specific internal temperature in conjunction with applicable guidelines and standards set forth by the USDA regarding the safe minimum cooking temperature and duration for the intended specific meat type, utilized for the natural shaped meat chip snack will be achieved.

FIG. 1 whereas item 30 represents the inspection of the dehydration process of the natural shaped meat chip. Wherein the quality assurance inspection of the dehydration process will verify that the natural shaped meat chip has successfully achieved a specific internal temperature in conjunction with applicable guidelines and standards set forth by the USDA regarding the safe minimum cooking temperature and duration for the intended specific meat type, utilized for the natural shaped meat chip snack.

Furthermore, wherein the commencing of this inspection, a dual probe digital thermometer will register with the first probe, the temperature of the interior of the dehydration equipment while the second probe will register the internal temperature of the natural shaped meat chip. This inspection will validate the intended parameters of both the internal temperature of the natural shaped meat chip as well as the temperature of the interior of the dehydration equipment. Therefore, upon the successful achievement of the dehydration process attaining internal temperature of the natural shaped meat chip based upon the applicable guidelines and standards set forth by the USDA regarding the specific meat type utilized, the natural shaped meat chip will proceed to the Infusion process or proceed directly to the baking process.

FIG. 1 whereas item 40 represents our infusion process of the natural shaped meat chip. Wherein our infusion process, the natural shaped meat chip is soaked/sprayed/bathed/misted or saturated for a pre-determined timeframe dependent upon desired potency of said application of ingredient(s) infused with our water-based ingredient(s) infusion mixture(s).

Furthermore, the ingredient(s) utilized in our water-based ingredient(s) infusion mixture(s) may be represented in their naturally occurring physical characteristic state (form) or processed thereof into a granular form based on pre-determined potency of said ingredient(s) and its intended applicable purpose within our water-based ingredient(s) infusion mixture(s).

Process execution will subsequently proceed to item 50 in the event of item 40 exclusion.

Additionally, our water-based ingredient(s) infusion mixture(s) in some embodiments may contain dietary supplement ingredient(s) for such purposes as potential health benefits which may include the promotion of dental care, skin health, immunity, digestive care, activity and/or a balance thereof general health to name a few but not limited to the examples mentioned.

Furthermore, the following examples of dietary supplement ingredient(s) to name a few but not limited to the examples mentioned, which can aid in the aforementioned potential health benefits, are vitamins, peppermint, lycopene, parsley seed, calcium, glucosamine, chondroitin, chicory root, soybeans, Jerusalem artichoke and probiotic bacteria.
Note: Not all the listed dietary supplement ingredient(s) are applicable for pet consumption.

Additionally, our water-based ingredient(s) infusion mixture(s) in some embodiments may contain flavor enhancing ingredient(s) for such purposes as increased palatability benefits.

Furthermore, examples of the increased palatability benefits to name a few but not limited to the examples mentioned, may include the preference of the consumer for a versatile tasting snack or a multitude of different varieties to choose from, also a product in which pets crave which subsequently enables the consumer to effectively and efficiently train and reward their pet for good behavior with a healthy snack.
Note: Not all the listed flavor enhancing ingredient(s) are applicable for pet consumption.

Additionally, our water-based ingredient(s) infusion mixture(s) in some embodiments may contain preservative ingredient(s) for increased product shelf life and/or product preservation.

Furthermore, examples of ingredient(s) for increasing the product shelf life and/or product preservation to name a few but not limited to the examples mentioned, may include sodium, argon gas and nitrogen gas. These examples assist in the increased product shelf life of the product and reduce the potential spoilage of the snack resulting in consumer safety and savings.
Note: Not all the listed preservative ingredient(s) are applicable for pet consumption.

Additionally, our water-based ingredient(s) infusion mixture(s) in some embodiments may contain coloring ingredient(s) for a potential favorable targeted product appearance and/or the ability to aid the consumer in the selection of a particular snack based on product color coding for variety selection.

Furthermore, examples of coloring ingredient(s) to impose a potential favorable targeted product appearance and/or the ability to aid the consumer in the selection of a particular snack, based on product color coding for variety selection to name a few but not limited to the examples mentioned, may include colorants or digestible dyes.
Note: Not all the listed colorant ingredient(s) are applicable for pet consumption.

FIG. 1 whereas item 50 represents the baking process of the natural shaped meat chip. Wherein the baking process of the natural shaped meat chip is commenced for a pre-determined temperature and timeframe dependent upon one, all/or a combination thereof the following natural shaped meat chip physical characteristic(s): cellular makeup, shape, size, thickness, texture, color, moisture content, crispiness, palatability and thus the appropriate intended desire of the natural shaped meat chip as a finalized human and pet natural shaped meat chip snack.

FIG. 1 whereas item 60 represents the inspection of the baking process of the natural shaped meat chip. Wherein the quality assurance inspection of the natural shaped meat chip will verify that the natural shaped meat chip has successfully achieved the following intended criteria: crispiness, overall appearance and palatability.

Furthermore, upon the successful achievement of the baking process intended parameters, the natural shaped meat chip will proceed to the cooling process.

FIG. 1 whereas item 70 represents the cooling process after baking of the natural shaped meat chip. Wherein the cooling process of the natural shaped meat chip consists of a pre-determined timeframe of said natural shaped meat chip dependent upon one, all/or a combination thereof the following natural shaped meat chip physical characteristic(s): cellular makeup, shape, size, thickness, texture, color, moisture content, crispiness and/or palatability.

FIG. 1 whereas item 80 represents the inspection of the cooling process of an edible meat chip snack. Wherein the quality assurance inspection of the cooling process will verify that the chip has successfully achieved the following intended physical characteristic(s): cellular makeup, shape, size, thickness, texture, color, moisture content, crispiness and palatability.

Furthermore, upon the successful inspection and validation of the cooling process, the natural shaped meat chip has successfully achieved the pre-determined process parameters set forth as the basis of the edible meat chip snack. Hereafter the natural shaped meat chip may be referred to as the natural shaped meat chip snack and subsequently will proceed to the packaging process.

FIG. 1 whereas item 90 represents the packaging process of the natural shaped meat chip snack. Wherein our packaging process, the natural shaped meat chip snack is weighed in accordance to our individual product label claim and deposited into correlating package/container.

Furthermore, the packaging components will be comprised in the composition thereof food grade, BPA (Bisphenol A) free material.

Additionally, a food grade desiccant (oxygen absorbing packet/a hygroscopic substance used as a drying agent) will be included/inserted within each individual package/container. Thus, for a limited time, for the intended purpose of ensuring the continuation of controlling the moisture content within the sealed package/container.

It is further stated that the interior portion of the package/container with inserted product contents and desiccant will undergo an air removal process ≥75% of the total volume of air content within said package/container.

Subsequently, when the air removal process is completed, package/container will be heat sealed successfully ensuring the air removal process and parameters thereof.

In further accordance with cGMP (current Good Manufacturing Practices), all packaging material will be weighed and tared from the final product to ensure accuracy of proper final product weight in conjunction with label claim.

FIG. 1 whereas item 100 represents the inspection of the packaging process of the natural shaped meat chip snack. Wherein the quality assurance inspection of the packaging process will verify the packaging process has successfully achieved the following intended criteria; weight of product within package in accordance to label claim, air removal of product package a ≥75% of total volume of air content of package, successful insertion of food grade desiccant within each individual product package and ensuring the integrity and effectiveness of the heat sealing process applied to each individual product package.

Furthermore, that the product meets and exceeds all cGMP and criteria.

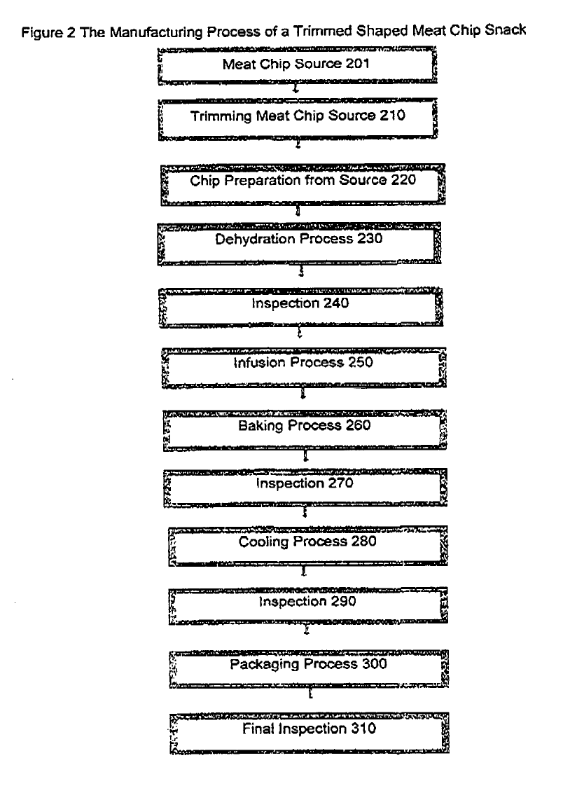

FIG. 2 is a flow chart illustrating a method of making a trimmed shaped human and pet meat chip snack in accordance with the second exemplary embodiment of the present disclosure.

Hereinafter the term “Trimmed” refers to an altered exterior shape of the original meat source.

It should be duly-noted that any descriptions of the process, whether within the detailed description or within the flow chart blocks represent segments, modules or steps that include one or more detailed instructions for the logical implementation of specific functions as they relate to the process.

The inclusion of alternate implementations or omissions thereof within the scope of work of the present disclosure may incur differences of the execution of said process from that shown and or discussed. This may include concurrent, subsequent and/or in reverse order of process execution dependent upon the involved functionality as understood by those reasonably skilled in the art of the present disclosure.

Referring now to FIG. 2 (the manufacturing process of a trimmed shaped meat chip snack) a human and pet meat chip snack for carnivorous animals, e.g. humans, canines, felines but not limited to, is shown with a method of making and packaging of said products.

FIG. 2 whereas item 201 represents the meat chip source utilized for the preparation of the trimmed shape meat chip. Wherein the meat chip source will undergo a cleaning process to produce an optimum source of meat from which the trimmed shape meat chip snack originates.

FIG. 2 whereas item 210 represents the trimming process of the exterior perimeter portion of the meat chip source. Wherein the exterior perimeter portion of the meat chip source is trimmed for the intended purpose of providing a pre-determined uniform shape from which the trimmed shape meat chip snack originates.

FIG. 2 whereas item 220 represents the creation of the trimmed shape meat chip through the process of slicing and or cutting a portion 1 slice from the meat chip source. Wherein the trimmed shaped meat chip will further have an average thickness in the range of 0.15875 cm to 3.175 cm prior to dehydration process.

FIG. 2 whereas item 230 represents the dehydration process of the trimmed shape meat chip. Due to the varying thickness and cellular makeup of the raw trimmed shape meat chip, dehydration times may vary. Wherein the trimmed shape meat chip will achieve industry average moisture content at completion of dehydration process of under 20%, however the trimmed shape meat chip will achieve optimum moisture content at completion of our dehydration process within the moisture range parameter of 4%-12%. Furthermore, a specific internal temperature in conjunction with applicable guidelines and standards set forth by the USDA regarding the safe minimum cooking temperature and duration for the intended specific meat type, utilized for the trimmed shape meat chip snack will be achieved.

FIG. 2 whereas item 240 represents the inspection of the dehydration process of the trimmed shape meat chip. Wherein the quality assurance inspection of the dehydration process will verify that the trimmed shape meat chip has successfully achieved a specific internal temperature in conjunction with applicable guidelines and standards set forth by the USDA regarding the safe minimum cooking temperature and duration for the intended specific meat type, utilized for the trimmed shape meat chip snack.

Furthermore, wherein the commencing of this inspection, a dual probe digital thermometer will register with the first probe, the temperature of the interior of the dehydration equipment while the second probe will register the internal temperature of the trimmed shape meat chip. This inspection will validate the intended parameters of both the internal temperature of the trimmed shape meat chip as well as the temperature of the interior of the dehydration equipment. Therefore, upon the successful achievement of the dehydration process attaining internal temperature of the trimmed shape meat chip based upon the applicable guidelines and standards set forth by the USDA regarding the specific meat type utilized, the trimmed shape meat chip will proceed to the infusion process or proceed directly to the baking process.

FIG. 2 whereas item 250 represents our infusion process of the trimmed shape meat chip. Wherein our infusion process, the trimmed shape meat chip is soaked/sprayed/bathed/misted or saturated for a pre-determined timeframe dependent upon desired potency of said application of ingredient(s) infused with our water-based ingredient(s) infusion mixture(s).

Furthermore, the ingredient(s) utilized in our water-based ingredient(s) infusion mixture(s) may be represented in their naturally occurring physical characteristic state (form) or processed thereof into a granular form based on pre-determined potency of said ingredient(s) and its intended applicable purpose within our water-based ingredient(s) infusion mixture(s).

Process execution will subsequently proceed to item 260 in the event of item 250 exclusion.

Additionally, our water-based ingredient(s) infusion mixture(s) in some embodiments may contain dietary supplement ingredient(s) for such purposes as potential health benefits which may include the promotion of dental care, skin health, immunity, digestive care, activity and/or a balance thereof general health to name a few but not limited to the examples mentioned.

Furthermore, the following examples of dietary supplement ingredient(s) to name a few but not limited to the examples mentioned, which can aid in the aforementioned potential health benefits, are vitamins, peppermint, lycopene, parsley seed, calcium, glucosamine, chondroitin, chicory root, soybeans, Jerusalem artichoke and probiotic bacteria.
Note: Not all the listed dietary supplement ingredient(s) are applicable for pet consumption.

Additionally, our water-based ingredient(s) infusion mixture(s) in some embodiments may contain flavor enhancing ingredient(s) for such purposes as increased palatability benefits.

Furthermore, examples of the increased palatability benefits to name a few but not limited to the examples mentioned, may include the preference of the consumer for a versatile tasting snack or a multitude of different varieties to choose from, also a product in which pets crave which subsequently enables the consumer to effectively and efficiently train and reward their pet for good behavior with a healthy snack.
Note: Not all the listed flavor enhancing ingredient(s) are applicable for pet consumption.

Additionally, our water-based ingredient(s) infusion mixture(s) in some embodiments may contain preservative ingredients for increased product shelf life, product preservation.

Furthermore, examples of ingredient(s) for increasing the product shelf life and or product preservation to name a few but not limited to the examples mentioned, may include sodium, argon gas and nitrogen gas. These examples assist in the increased product shelf life of the product and reduce the potential spoilage of the snack resulting in consumer safety and savings.
Note: Not all the listed preservative ingredient(s) are applicable for pet consumption.

Additionally, our water-based ingredient(s) infusion mixture(s) in some embodiments may contain coloring ingredient(s) for a potential favorable targeted product appearance and/or the ability to aid the consumer in the selection of a particular snack based on product color coding for variety selection.

Furthermore, examples of coloring ingredient(s) to impose a potential favorable targeted product appearance and or the ability to aid the consumer in the selection of a particular snack based on product color coding for variety selection to name a few but not limited to the examples mentioned, may include colorant(s) or digestible dyes.
Note: Not all the listed colorant ingredient(s) are applicable for pet consumption.

FIG. 2 whereas item 260 represents the baking process of the trimmed shape meat chip. Wherein the baking process of the trimmed shape meat chip is commenced for a pre-determined temperature and timeframe dependent upon one, all or a combination thereof the following trimmed shape meat chip physical characteristic(s): cellular makeup, shape, size, thickness, texture, color, moisture content, crispiness, palatability and thus the appropriate intended desire of the trimmed shape meat chip as a finalized human and pet trimmed shape meat chip snack.

FIG. 2 whereas item 270 represents the inspection of the baking process of the trimmed shape meat chip. Wherein the quality assurance inspection of the trimmed shape meat chip will verify that the trimmed shape meat chip has successfully achieved the following intended criteria: crispiness, overall appearance and palatability.

Furthermore, upon the successful achievement of the baking process intended parameters, the trimmed shape meat chip will proceed to the cooling process.

FIG. 2 whereas item 280 represents the cooling process after baking of the trimmed shape meat chip. Wherein the cooling process of the trimmed shape meat chip consists of a pre-determined timeframe of said trimmed shape meat chip dependent upon one, all/or a combination thereof the following trimmed shape meat chip physical characteristic(s): cellular makeup, shape, size, thickness, texture, color, moisture content, crispiness and/or palatability.

FIG. 2 whereas item 290 represents the inspection of the cooling process of an edible meat chip snack. Wherein the quality assurance inspection of the cooling process will verify that the chip has successfully achieved the following intended physical characteristic(s): cellular makeup, shape, size, thickness, texture, color, moisture content, crispiness and palatability.

Furthermore, upon the successful inspection and validation of the cooling process, the trimmed shape meat chip has successfully achieved the pre-determined process parameters set forth as the basis of the edible meat chip snack. Hereafter the trimmed shape meat chip may be referred to as the trimmed shape meat chip snack and subsequently will proceed to the packaging process.

FIG. 2 whereas item 300 represents the packaging process of the trimmed shape meat chip snack. Wherein our packaging process, the trimmed shape meat chip snack is weighed in accordance to our individual product label claim and deposited into correlating package/container.

Furthermore, the packaging components will be comprised in the composition thereof food grade, BPA (Bisphenol A) free material.

Additionally, a food grade desiccant (oxygen absorbing packet/a hygroscopic substance used as a drying agent) will be included/inserted within each individual package/container. Thus, for a limited time, for the purpose of ensuring the continuation of controlling the moisture content within the sealed package/container.

It is further stated that the interior portion of the package/container with inserted product contents and desiccant will undergo an air removal process ≥75% of the total volume of air content within said package/container.

Subsequently, when the air removal process is completed, package/container will be heat sealed successfully ensuring the air removal process and parameters thereof.

In further accordance with cGMP, all packaging material will be weighed and tared from the final product to ensure accuracy of proper final product weight in conjunction with label claim.

FIG. 2 whereas item 310 represents the inspection of the packaging process of the trimmed shape meat chip snack. Wherein the quality assurance inspection of the packaging process will verify the packaging process has successfully achieved the following intended criteria; weight of product within package in accordance to label claim, air removal of product package ≥75% of total volume of air content of package. Successful insertion of food grade desiccant within each individual product package and ensuring the integrity and effectiveness of the heat sealing process applied to each individual product package.

Furthermore, that the product meets and exceeds all cGMP and criteria.

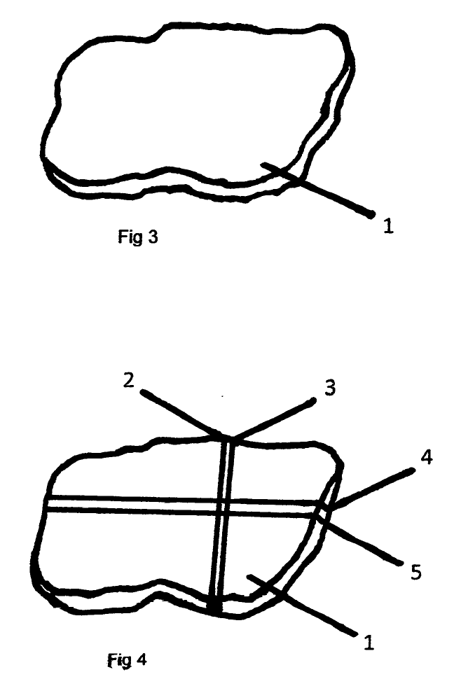

FIG. 3 is an illustration of a pre-selected meat source in which the natural shape and/or trimmed shape meat chip snack will be derived from.

FIG. 4-18 are illustrations of the utilization of FIG. 3 (a pre-determined meat source) and associated various cutting options thereof.

FIG. 4 is a top view of a “Natural” meat source of FIG. 3 with cut line markings. Hereinafter, the term “Natural” refers to an unaltered exterior shape of the original meat source. These cut line markings are numerically indicated to associate the directional slice/cut pattern of transverse slice/cuts (against the grain) from longitudinal slice/cuts (with the grain). Furthermore, the transverse slice/cuts of the meat source (FIG. 4) will be numerically represented as 2 and 3 whereas the longitudinal slice/cuts of the meat source (FIG. 4) will be numerically represented as 4 and 5 respectfully, in accordance with the first exemplary embodiment of the present disclosure.

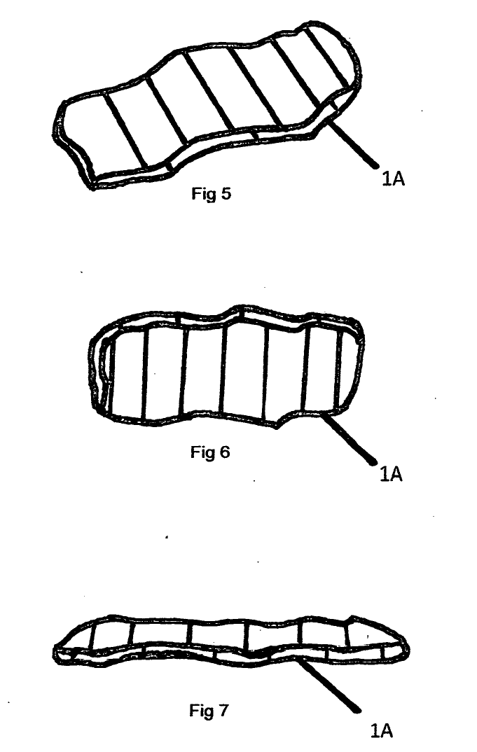

FIG. 5 is a top view of a Natural slice of the meat source of FIG. 4 along the cut-lines 2 and 3 hereafter numerically referenced as 1A in accordance with the first exemplary embodiment of the present disclosure.

FIG. 6 is a front view of a Natural slice of the meat source of FIG. 4 along the cut-lines 2 and 3 hereafter numerically referenced as 1A in accordance with the first exemplary embodiment of the present disclosure.

FIG. 7 is a side view of a Natural slice of the meat source of FIG. 4 along the cut-lines 2 and 3 hereafter numerically referenced as 1A in accordance with the first exemplary embodiment of the present disclosure.

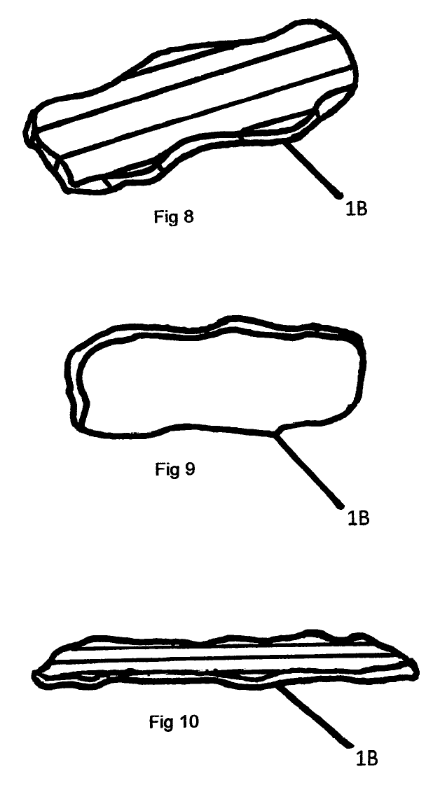

FIG. 8 is a top view of a Natural slice of the meat source of FIG. 4 along the cut-lines 4 and 5 hereafter numerically referenced as 1B in accordance with the first exemplary embodiment of the present disclosure.

FIG. 9 is a front view of a Natural slice of the meat source of FIG. 4 along the cut-lines 4 and 5 hereafter numerically referenced as 1B in accordance with the first exemplary embodiment of the present disclosure.

FIG. 10 is a side view of a Natural slice of the meat source of FIG. 4 along the cut lines 4 and 5 hereafter numerically referenced as 1B in accordance with the first exemplary embodiment of the present disclosure.

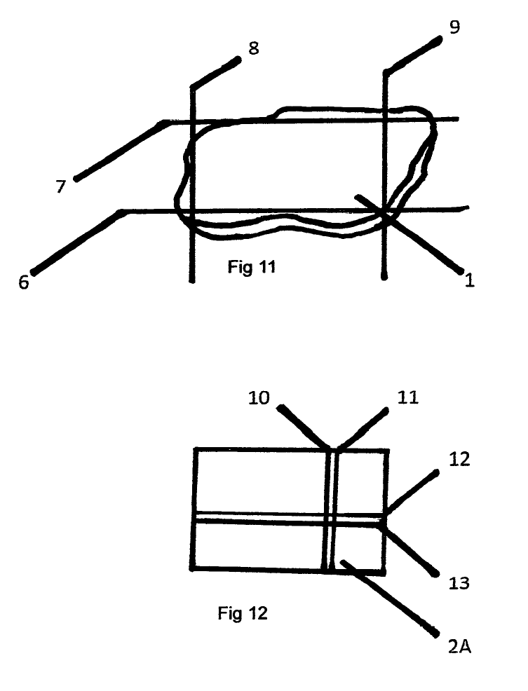

FIG. 11 is a top view of a Natural meat source of FIG. 3 with exterior perimeter cut line markings. These cut line markings are numerically indicated to associate the directional slice/cut for the exterior perimeter shaping pattern of the meat source in FIG. 11. Furthermore, the longitudinal slice/cuts of the exterior perimeter shaping pattern of the meat source in FIG. 11 will be numerically referenced as 6 and 7, whereas the transverse slice/cuts of the exterior perimeter shaping pattern of the meat source in FIG. 11 will be numerically referenced as 8 and 9, in accordance with the second exemplary embodiment of the present disclosure. The exterior perimeter cut line markings will establish a pre-determined altered shape of the original meat source subsequently referenced hereinafter as “Trimmed”.

FIG. 12 is a top view of a Trimmed meat source of FIG. 11 with cut line markings, hereafter numerically referenced as 2A. These cut line markings are numerically indicated to associate the directional slice/cut pattern of transverse slice/cuts (against the grain) from longitudinal slice/cuts (with the grain). Furthermore item 10 and item 11 will represent the transverse slice/cuts of the meat source while item 12 and item 13 will represent the longitudinal slice/cuts of the meat source, in accordance with the second exemplary embodiment of the present disclosure.

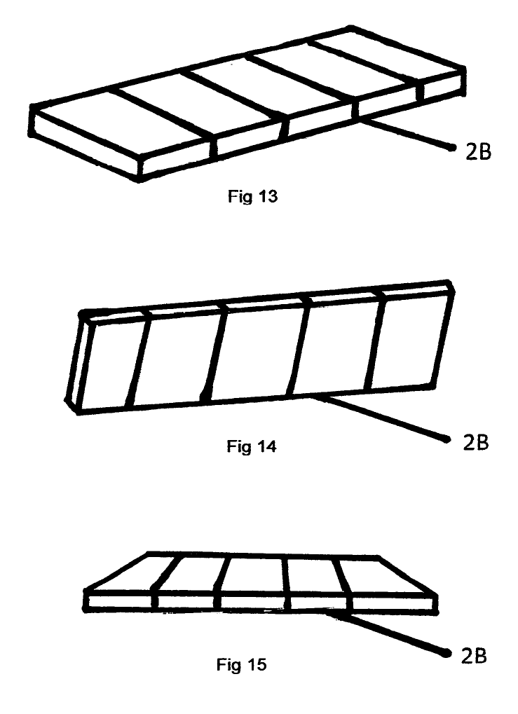

FIG. 13 is a top view of a Trimmed slice of the meat source of FIG. 12 along the cut-lines 10 and 11 hereafter numerically referenced as 2B in accordance with the second exemplary embodiment of the present disclosure.

FIG. 14 is a front view of a Trimmed slice of the meat source of FIG. 12 along the cut-lines 10 and 11 hereafter numerically referenced as 2B in accordance with the second exemplary embodiment of the present disclosure.

FIG. 15 is a side view of a Trimmed slice of the meat source of FIG. 12 along the cut-lines 10 and 11 hereafter numerically referenced as 2B in accordance with the second exemplary embodiment of the present disclosure.

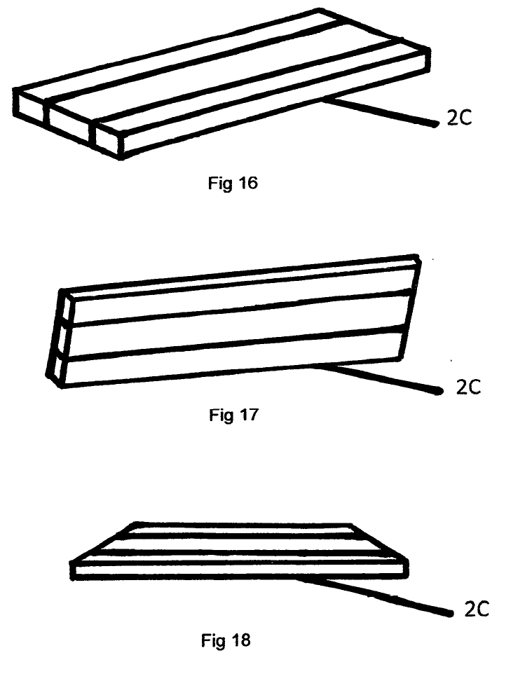

FIG. 16 is a top view of a Trimmed slice of the meat source of FIG. 12 along the cut-lines 12 and 13 hereafter numerically referenced as 2C in accordance with the second exemplary embodiment of the present disclosure.

FIG. 17 is a front view of a Trimmed slice of the meat source of FIG. 12 along the cut-lines 12 and 13 hereafter numerically referenced as 2C in accordance with the second exemplary embodiment of the present disclosure.

FIG. 18 is a side view of a Trimmed slice of the meat source of FIG. 12 along the cut-lines 12 and 13 hereafter numerically referenced as 2C in accordance with the second exemplary embodiment of the present disclosure.

It is highly emphasized that the embodiments of the present disclosure described above are mere possible examples of logical implementations as they relate to the process set forth for a clear understanding of the principles of the disclosure.

Additionally, embodiments of the present disclosure provide a food product (an edible meat chip snack product for human and pet consumption) and subsequent method thereof making the same. It is intended that both, the first embodiment (the natural shaped meat chip snack) and the second embodiment (the trimmed shape meat chip snack) of the present disclosure are representative of alternative methods of making the same edible meat chip snack.

Furthermore, alternate modifications and variations potentially made to the embodiments of the present disclosure described above will not substantially detract from the original intent, principles and/or spirit of the disclosure.

The intention for inclusion herein within the scope of this disclosure and the present disclosure of all such modifications and variations thereof are protected by the following claims.

What is claimed is:

1) An edible meat chip snack e.g. Chicken Chip, Beef Chip, Turkey Chip or Pork Chip to name a few but not limited to the examples mentioned, comprised as a singular solid chip, sliced or cut from a pre-selected meat chip source. Whereas the pre-selected meat chip source has A) been left unaltered in its natural shape or B) has been proportionally pre-determined and therefore cut into a trimmed shape. Furthermore, wherein the edible meat chip snack subsequently undergoes a dehydration process then baked to allow for an enhanced flavor.

2) The edible meat chip snack of claim #1, wherein the edible meat chip snack undergoes our infusion process, utilizing our water-based ingredient(s) infusion mixture(s) for the purpose of infusing one or a mixture thereof additional dietary supplement ingredient(s) for health benefits.

3) The edible meat chip snack of claim #1, wherein the edible meat chip snack undergoes our infusion process, utilizing our water-based ingredient(s) infusion mixture(s) for the purpose of infusing one or a mixture thereof additional flavor enhancing ingredient(s) for palatability benefits.

4) The edible meat chip snack of claim #1, wherein the edible meat chip snack undergoes our infusion process, utilizing our water-based ingredient(s) infusion mixture(s) for the purpose of infusing one or a mixture thereof additional preservative ingredient(s) for product preservation benefits.

5) The edible meat chip snack of claim #1, wherein the edible meat chip snack undergoes our infusion process, utilizing our water-based ingredient(s) infusion mixture(s) for the purpose of infusing one or a mixture thereof additional colorant ingredient(s) for variety and targeted product appearance benefits.

6) The edible meat chip snack of claim #1, #2, #3, #4, #5, further having an average thickness in the range of 0.1 am to 1.27 cm.

7) The edible meat chip snack of claim #1, #2, #3, #4, #5, further having an average length in the range of 0.1 cm to 30.48 cm and an average width in the range of 0.1 cm to 22.86 cm.

8) The edible meat chip snack of claim #1, #2, #3, #4, #5, wherein the edible meat chip snack has a finished product moisture content in the range of 4%-12%.

9) The edible meat chip snack of claim #1, #2, #3, #4, #5, wherein the edible meat chip snack varies in shape and size due to in part by:
A) The “Natural” proportioned (unaltered) attributes of the meat chip source,
B) The pre-determined “Trimmed” (altered) proportioning of the meat chip source,
C) The effect our total process has on the physical characteristics of our finished product e.g. initial slicing/cutting, directional slicing/cutting, thickness, dehydration, rehydration/infusion of additional ingredient(s) (if applicable) and baking.

10) The edible meat chip snack of claim #2, #3, #4, #5, wherein the edible meat chip snack will vary based upon the appropriate proportioning of the intended ingredient(s) and correlating potency within the infusion of one, a mixture or a combination thereof but not limited to dietary supplement ingredient(s), flavor enhancing ingredient(s), preservative ingredient(s), and/or colorant ingredient(s).
